(19) United States
(12) Patent Application Publication
(10) Pub. No.: US 2025/0062565 A1
(43) Pub. Date: Feb. 20, 2025

(54) RELIABLE CONNECTOR ASSEMBLY AND HOUSING THEREOF

(71) Applicant: Amphenol East Asia Limited (Hong Kong), Tsimshatsui (HK)

(72) Inventors: Mei-Chien Wu, Taoyuan City (TW); Lo-Wen Lu, Taoyuan City (TW); Wen Te Hsu, Taoyuan City (TW)

(73) Assignee: Amphenol East Asia Limited (Hong Kong), Tsimshatsui, (HK)

(21) Appl. No.: 18/802,191

(22) Filed: Aug. 13, 2024

(30) Foreign Application Priority Data
Aug. 17, 2023 (TW) 112208787
Nov. 1, 2023 (TW) 112211851

(51) Int. Cl. H01R 13/518

(52) U.S. Cl. CPC H01R 13/518

(57) ABSTRACT

Reliable connector assembly and housing thereof. The housing may include a first portion having first spaces for receiving first connectors and a second portion having second spaces connected to the first spaces for receiving second connectors configured to mate with the first connectors. The first portion comprises a platform comprising a surface in a plane perpendicular to the mating direction at an interface of the first portion and the second portion. Such a configuration reduces the risk of exerting excessive force onto the connectors and increase the reliability of the connector assembly.

### CROSS-REFERENCE TO RELATED APPLICATIONS

This application claims priority to and the benefit of Taiwanese Patent Application No. 112211851, filed on Nov. 1, 2023. This application also claims priority to and the benefit of Taiwanese Patent Application No. 112208787, filed on Aug. 17, 2023. The contents of these applications are incorporated herein by reference in their entirety.

### TECHNICAL FIELD

The present disclosure relates to interconnection systems, such as those including electrical connectors, used to interconnect electronic assemblies.

### BACKGROUND

A connector is an electronic device used to connect two or more pieces of electronic equipment to realize the transmission of electrical energy and signals. Connectors have been widely used in various industrial fields such as communications, information technology, automobiles, consumer electronics, etc. In recent years, the increasing demand for thinner and lighter electronic equipment has led to a trend in connector design toward miniaturization and lower profile designs.

### SUMMARY

Aspects of the present disclosure relate to reliable connector assembly and housing thereof.

Some embodiments relate to a housing for holding a plurality of connectors. The housing may comprise a first portion comprising a plurality of first spaces configured to receive a plurality of first connectors. The housing may further comprise a second portion comprising a plurality of second spaces connected to respective first spaces of the plurality of first spaces and configured to receive a plurality of second connectors. The plurality of second connectors may be configured to mate with the plurality of first connectors in a mating direction. The first portion may comprise a platform comprising a surface in a plane perpendicular to the mating direction at an interface of the first portion and the second portion.

Optionally, an inner wall of the first portion comprises at least one first elongated protrusion, the at least one first elongated protrusion extending along the inner wall of the first portion in the mating direction.

Optionally, an inner wall of the second portion comprises at least one second elongated protrusion, the at least one second elongated protrusion extending along the inner wall of the second portion in the mating direction.

Optionally, the housing comprises die-cast metal.

Optionally, the first portion comprises a plurality of openings extending into the plurality of first spaces along a first direction perpendicular to the mating direction.

Optionally, the second portion comprises at least one ventilation hole extending along the first direction from a first side of the second portion to a second side of the second portion, opposite the first side.

Optionally, the at least one ventilation hole is positioned between two adjacent second spaces of the plurality of second spaces.

Optionally, the first spaces are each configured to receive a respective plug connector and the second spaces are each configured to receive a respective socket connector.

Optionally, the platform is a first platform extending from a first side of the first portion; and the housing further comprises a second platform extending from a second side of the first portion opposite the first side.

Optionally, the first portion and the second portion are separably coupled.

Optionally, each second space of the plurality of second spaces comprises a limit portion extending from an inner wall of the second portion and configured to position adjacent second connectors apart from each other.

Some embodiments relate to a connector assembly. The connector assembly may comprise a housing comprising. The housing may comprise a first portion comprising a plurality of first spaces. The housing may further comprise a second portion comprising a plurality of second spaces. The first portion may comprise a platform adjacent to the second portion having a surface in a plane perpendicular to a mating direction. Each first space of the plurality of first spaces may be connected with a respective second space of the plurality of second spaces. The connector assembly may further comprise a plurality of first connectors disposed in the plurality of first spaces. The connector assembly may further comprise a plurality of second connectors disposed in the plurality of second spaces and connected with respective ones of the plurality of first connectors.

Optionally, the plurality of first connectors extend from the plurality of first spaces into the plurality of second receiving spaces to mate with the plurality of first connectors.

Optionally, the platform is positioned to block movement of the plurality of first connectors toward the plurality of second connectors when the first connectors are in a mated position.

Optionally, the platform is positioned to abut a first end of each first connector when each first connector of the plurality of first connectors is mated with a respective second connector of the plurality of second connectors.

Optionally, the respective first end of each first connector comprises a slot configured to receive a third connector.

Optionally, a height of a top surface of each second connector is lower than a height of a top surface of the second region.

Optionally, the first spaces of the plurality each comprise an opening extending into the first spaces along the first direction and the first connectors of the plurality each comprise a connection end configured to extend through a respective opening in the first direction.

Optionally, at least one first space of the plurality of first spaces comprises a wall having a latch hole configured to receive a latching member of one first connector of the plurality of first connector.

Some embodiments relate to a housing for holding a plurality of connectors. The housing may comprise a plurality of shells extending along a mating direction each configured to hold a first connector and a second connector. Each of the plurality of shells may comprise a first end for holding the first connector and a second end opposite the first end for holding the second connector. The housing may comprise a platform extending from each of the plurality of shells between the first end and the second end, the platform having a surface perpendicular to the mating direction and configured to abut the plurality of first connectors.

Optionally, the plurality of shells are a plurality of inner shells; and the housing comprises an outer shell, wherein each inner shell is separably coupled to the outer shell.

Optionally, the platforms of each inner shell are first platforms and the outer shell comprises a second platform having a surface perpendicular to the mating direction and configured to abut the first platform of one or more inner shells when coupled to the inner shell.

Optionally, the second platform is welded to the first platform of a respective inner shell when the respective inner shell and outer shell are coupled.

Some embodiments relate to a housing configured for holding multiple connectors. The housing may include a docking region. The docking region may comprise a plurality of docking spaces to accommodate a plurality of plug connectors. A length of the docking region in a longitudinal axis direction may be greater than that of a mating region to form a load-bearing platform. The load-bearing platform can be configured to abut against the plug connectors. The housing may additionally or alternatively include a mating region. The mating region may comprise a plurality of mating spaces to accommodate a plurality of socket connectors. The mating spaces may be connected with the docking spaces, respectively. The docking region and the mating region may be aligned in a mating direction.

Optionally, the housing is made of metal.

Optionally, the docking region comprises at least one first elongated protrusion corresponding to an inner wall of the docking space.

Optionally, the mating region comprises at least one second elongated protrusion corresponding to an inner wall of the mating space.

Optionally, the docking region comprises a plurality of through openings, wherein the through openings extend along the longitudinal axis direction and are connected with the docking spaces.

Optionally, the mating region comprises at least one ventilation hole, wherein the ventilation hole extends along the longitudinal axis direction, runs through opposite sides of the mating region, and is located between two adjacent mating spaces.

Optionally, the ventilation hole is connected with at least one of the mating spaces.

Some embodiments relates to a connector assembly. The connector assembly may comprise a housing as described herein, and a plurality of socket connectors disposed in respective docking spaces of the housing.

Optionally, a height of a top surface of the socket connector is lower than a height of a top surface of the mating region.

Optionally, the height of the top surface of the socket connector does not exceed a position of a bottom side of an adjacent ventilation hole.

Some embodiments relate to a housing configured for holding multiple connectors. The housing may comprise a plurality of inner shells and an outer shell. The inner shells may include a docking region and a mating region aligned in a mating direction. The outer side of each inner shell may include at least one first platform. The first platforms of the same inner shell may be located at or near the junction of the docking region and the mating region. The docking region may comprise a docking space configured to accommodate a male connector. The mating region may comprise a mating space configured to accommodate a female connector. The mating space and the docking space may be connected with each other. The top of the outer shell may comprise a plurality of second platforms facing outward. An accommodating space may be provided inside the outer shell. When each inner shell is assembled into the accommodating space, the second platforms may press against and are fixed to the corresponding first platforms.

Optionally, the inner shells are separated from each other by a distance.

Optionally, at least one side of the outer shell comprises a plurality of limit portions.

Optionally, two adjacent limit portions, respectively, press against different inner shells.

Optionally, at least one side of the outer shell comprises a plurality of through holes, each of which is connected with the accommodating space.

Optionally, the limit portion may be formed by stamping and bending a local area of the outer shell, and the through hole will be formed therein.

Optionally, the first platform and the second platform are fixed to each other by welding.

Optionally, one side of the inner shell comprises at least one locking portion that can press inward against the female connector of the mating space.

Optionally, the inner shell comprises an opening that connects the mating space and the accommodating space.

Optionally, the length of the docking region is different from that of the mating region in the longitudinal axis direction and/or vertical axis direction.

Optionally, the bottom end of the outer shell comprises at least one positioning portion for fixation to a circuit board.

These techniques may be used alone or in any suitable combination. The foregoing is a non-limiting summary of the application, which is defined by the attached claims.

### BRIEF DESCRIPTION OF THE DRAWINGS

The accompanying drawings may not be intended to be drawn to scale. In the drawings, each identical or nearly identical component that is illustrated in various figures may be represented by a like numeral. For purposes of clarity, not every component may be labeled in every drawing. In the drawings:

FIG. 1 is a partially exploded perspective view of a connector assembly, showing a housing holding plug connectors and socket connectors with one of each moved outside the housing, according to some embodiments;

FIG. 2 is a perspective view of the connector assembly of FIG. 1, according to some embodiments;

FIG. 3 is a side view of the housing of the connector assembly of FIG. 1, according to some embodiments;

FIG. 4A is a partial cross-sectional perspective view of the connector assembly of FIG. 1, with the plug connectors and socket connectors hidden, showing a first inner side of the housing, according to some embodiments;

FIG. 4B is a partial cross-sectional perspective view of the connector assembly of FIG. 1, with the plug connectors and socket connectors hidden, showing a second inner side of the housing, according to some embodiments;

FIG. 5A is a partial cross-sectional perspective view of the connector assembly of FIG. 1, showing the socket connectors, according to some embodiments;

FIG. 5B is a partial cross-sectional perspective view of the connector assembly of FIG. 1, with the socket connectors hidden, according to some embodiments;

FIG. 6 is a front view of the connector assembly of FIG. 1, showing the plug connectors, according to some embodiments;

FIG. 7 is a partially exploded perspective view of a connector assembly, showing a housing configured for holding plug connectors and socket connectors with one of each disposed in the housing and one of each moved outside the housing, according to some embodiments;

FIG. 8 is an exploded front perspective view of the housing of the connector assembly of FIG. 7, showing a socket connector outside the housing, according to some embodiments;

FIG. 9 is an exploded rear perspective view of the housing of FIG. 8, showing the socket connector outside the housing, according to some embodiments;

FIG. 10 is a cross-sectional view of a portion of the connector assembly of FIG. 7, showing the housing with a plug connector and socket connectors disposed therein, according to some embodiments;

FIG. 11 is a top perspective view of the portion of the connector assembly of FIG. 10, with the plug connector hidden, according to some embodiments; and

FIG. 12 is a cross-sectional perspective view of the outer shell of the connector assembly of FIG. 7, according to some embodiments.

### DETAILED DESCRIPTION

The inventors have recognized and appreciated techniques for making reliable connector assemblies. The inventors have recognized and appreciated that miniaturization of electronics may require disposing connectors in close proximity and/or within a limited space. For example, a vehicle (e.g., an electric automobile) may be equipped with a basic audio system, a navigator, advanced autopilot technology, etc., which need to be implemented by a large number of electronic devices, so the vehicle may have dozens or even hundreds of electronic control units (ECUs), and such electronic devices or ECUs need to be connected to each other by connectors to transmit information and electric power. In order to provide comfortable interior space for users in automobiles, the internal space for apparatuses in automobiles will have to be reduced, connectors are usually distributed to various corners of an automobile, which may cause problems such as difficult maintenance, complex wiring, and possible signal interference.

Techniques described herein may enable connectors of various numbers and having different configurations to be disposed in a limited space such as a space central to an electronic, which may reduce wiring complexity, minimize interference and noise, and therefore improving the overall performance of the system.

Techniques described herein may address problems that might be caused by reducing the sizes of connectors. For example, making connectors thin and light may reduce the mechanical fault tolerance of two connectors during mating. Thinner and lighter designs make the insertion or extraction operation more difficult, as an accurate plugging angle is required for proper mating. Additionally, it may also require greater operating force for mating or unmating thinner and lighter connectors. As such, the techniques described herein may protect thinner and lighter connectors during mating and operation of the connectors.

As another example, due to miniaturization, the mechanical strength of the connector may be reduced, making it easier for connectors to be damaged by external forces. As a further example, a user may exert too much force and cause excessive mechanical stress and damage to the two connectors. Further due to miniaturization, the connector may not have enough volume for effective heat dissipation, resulting in reduced heat resistance under high current or high frequency conditions. In particular, when many connectors are densely arranged, it could be more difficult to provide a good heat dissipation path. In addition, as the size of connectors shrinks, they may be more susceptible to or generate electromagnetic interference, resulting in a decrease in the overall performance of the electronic equipment. Although some manufacturers have designed auxiliary structures to enhance the stability of connectors during plugging, the existing structures are generally too complex and often have a negative impact on production efficiency.

According to aspects of the present disclosure, a connector assembly of an electronic system may have a housing for providing load-bearing capabilities for multiple connectors during mating, and support and guide the connectors during mating. The housing may include a first portion having first spaces for receiving first connectors (e.g., plug connectors) and a second portion having second spaces connected to the first spaces for receiving second connectors (e.g., socket connectors) configured to mate with respective first connectors. In that way, the housing of the connector assembly may reliably support and hold multiple pairs of mated connectors.

The first portion may include a platform extending beyond the second portion in a direction perpendicular to the mating direction. The platform may be a load-bearing platform for capable of withstanding, at least in part, load due to the force of the connectors during mating. Such a load-bearing platform reduces the risk of damage from applying excessive force onto mating portions the first and second connectors. For example, the load-bearing platform may have a planar surface and may be positioned at an interface of the first and second portions abut a portion of the first connector that has a higher mechanical strength than the mating portion so as to distribute the force applied to the mating portions of the first and second connectors. The platform may thus prevent movement of the connectors in the mating direction when the connectors are in the mated position. Such a configuration may reduce the risk of damaging the connectors during mating or of accidentally dislocating the connectors. The platform may include a surface for guiding a connector into the proper positioning during mating of the connector with another connector. For example, the platform may both support and guide various connectors during mating and operation of the electronic system. In that way, the load-bearing platform may provide control over both the plugging positions and distances between the connectors and the housing may provide protection from damage due to excessive force or otherwise. As such, connector assemblies having a housing including a load-bearing platform capable of accommodating a plurality of socket connectors and/or a plurality of plug connectors are provided herein.

The inventors have further recognized and appreciated that, as the functions of electronic devices increases, the demand for connectors has similarly increased, while available space for the connectors has decreased. Further, the form factors of various connectors may change over time or may depend on the function of the connector. As such, a fixed housing limits the manufacturing and design flexibility for configuring connectors for various electronic devices.

Accordingly, some aspects of the present disclosure relates to a reliable connector assembly having a load-bearing housing with modular shells. In some embodiments, the connector housing may comprise a plurality of inner shells and an outer shell, wherein the inner shells can be fixed to the outer shell. A plurality of socket connectors can be assembled into the connector housing and a plurality of plug connectors can be plugged into the corresponding socket connectors through the connector housing. Further, when the form of the socket connector or the plug connector has changed, the original outer shell can be used by simply replacing the form of the inner shell. Similarly, inner shells of different forms or types can be assembled into the same outer shell. Therefore the modular design of the connector housing allows that the connector is durable and flexible, while allowing a reduction of production and maintenance costs.

Exemplary interconnection systems having one or more of the features will be further described in detail below in conjunction with specific embodiments and with reference to the drawings. A person of ordinary skill in the art can understand the advantages and effects of the present disclosure from the contents disclosed in the present disclosure, and the technology described herein can be implemented or applied through other different specific embodiments. Various details in the present description may also be based on different viewpoints and applications, and various modifications and changes may be made without departing from the concept of the present disclosure. In addition, it should be stated in advance that the drawings of the present disclosure are only simple illustrations and are not depictions based on actual size. In addition, unless otherwise clearly indicated or defined in the context, the meanings of “a” and “the” in the present disclosure include the form of plural. In addition, the relevant technical contents of the present disclosure will be further described in detail by the following embodiments, but the disclosed contents are not intended to limit the scope of protection of the present disclosure.

It should be understood that the terms used herein generally have their ordinary meanings in the art, and in the event of conflict, any definitions given herein shall prevail. Since the same thing can be expressed in many ways, alternative words and synonyms may be used for any term discussed or described herein, and there is no particular limitation as to whether the term is stated or discussed herein. The use of one or more synonyms does not exclude the use of other synonyms. The embodiments used anywhere in the description of the present disclosure, including the use of any terms, are only illustrative and in no way limit the scope and meaning of the present disclosure or any terms. Likewise, the present disclosure is not limited to various embodiments disclosed in the description. Although the terms such as first, second or third may be used herein to describe various elements, the elements should not be limited by the foregoing terms. The foregoing terms are mainly used to distinguish one element from another element and should not impose any substantial limitations on any element, and should not limit the assembly or arrangement sequence of the elements in practical applications. In addition, the direction terms mentioned in the embodiments, such as “up”, “down”, “front”, “back”, “left”, and “right”, are only for reference to the directions in the drawings. For example, the use of the directional terms is for illustrative purposes and is not intended to limit the scope of protection of the present disclosure. In addition, the term “or” used herein shall include any one or combination of more of the associated listed items, depending on actual situations.

Furthermore, the terms such as “substantially” or “approximately” used herein may refer to a value or an average of a plurality of values within a range of deviations for a specific value that can be recognized or determined by a person of ordinary skill in the art, including taking into account the limitations of the measurement system or equipment, and there are certain specific errors that may occur when measuring the specific value. For example, a value described by substantially can include ±5%, ±3%, ±1%, ±0.5% or ±0.1% of the specific value, and one or more standard deviation ranges thereof.

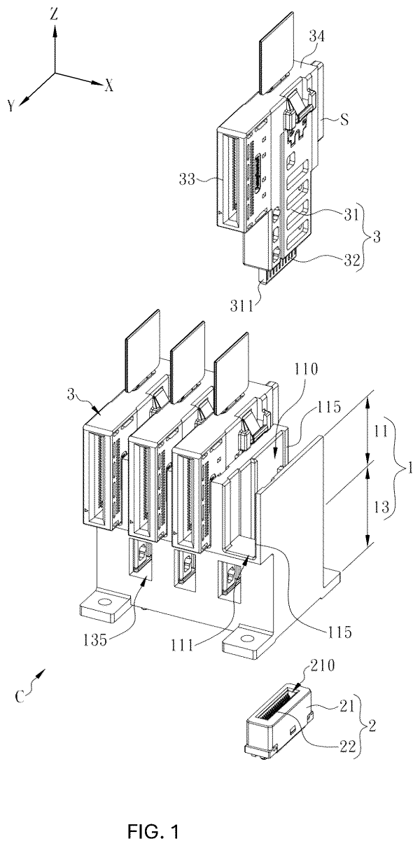

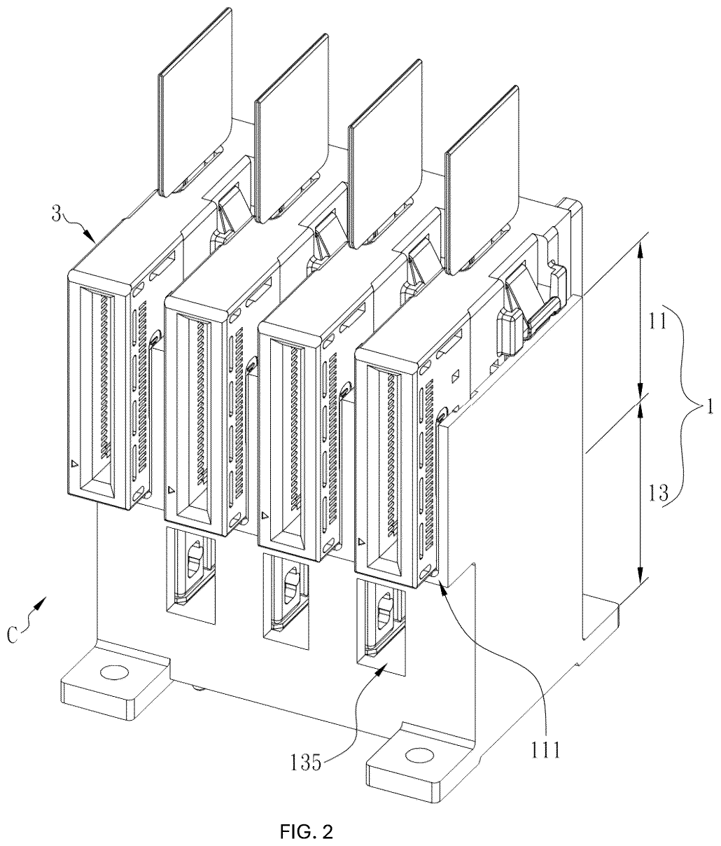

Some aspects of the present disclosure relates to a connector assembly with multiple connectors and a housing configured for holding the multiple connectors. Referring to FIGS. 1 to 2, in an embodiment, the connector assembly C includes a housing 1 and a plurality of socket connectors 2, and a plurality of plug connectors 3 configured for mating with socket connectors 2 through the housing 1. For the convenience of description, the spatial form of an element of the present disclosure may be described in connection with three mutually orthogonal axes which are a horizontal axis (X-axis), a longitudinal axis (Y-axis) and a vertical axis (Z-axis), respectively, for example, three axis directions shown in FIG. 1. The vertical axis direction may refer to a mating direction, in which a plug connector may mate with a socket connector.

It is particularly noted here that the appearance and structure of both the socket connector 2 and the plug connector 3 can be changed according to desired functions and uses. Although exemplary features of the socket connector 2 and the plug connector 3 will be described below, the housing 1 may hold connectors with one or more different features. For example, other elements can be added to the socket connector 2 and the plug connector 3, and even the partial structures of both the socket connector 2 and the plug connector 3 can be interchanged as explained previously. Referring back to FIGS. 1 and 2, the socket connector 2 includes a receiving body 21 and at least one receiving terminal 22, wherein the receiving body 21 can be made of insulating material, and is internally provided with at least one slot 210 for accommodating the receiving terminal 22. The plug connector 3 includes a plug body 31 and at least one plug terminal 32, wherein the plug body 31 can be made of insulating material. Plug body 31 may comprise a tongue plate 311 protruding from a bottom side thereof. In some embodiments, the plug terminal 32 can be arranged on the tongue plate 311 in the form of a gold finger. For example, in other embodiments of the present disclosure, the structure of the socket connector 2 related to the receiving terminal 22, and the structure of the plug connector 3 related to the plug terminal 32 can be arranged interchangeably with each other.

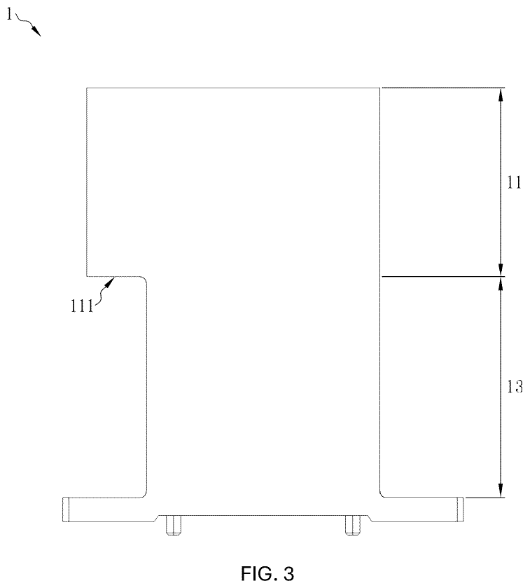

Referring to FIGS. 1 to 3, the housing 1 can be made of metal material, and may include a docking region 11 and a mating region 13 aligned in the mating direction, wherein the length of the docking region 11 in the longitudinal axis direction is greater than that of the mating region 13 to form a load-bearing platform 111, and the docking region 11 is further provided with a plurality of docking spaces 110, so that the plug connector 3 can extend into the docking spaces 110 in the mating direction, and a part of the bottom side of the plug connector 3 can abut against the load-bearing platform 111, thereby improving the stability of the plug connector 3 in the housing 1. In some embodiments, the load-bearing platform 111 is located on the front side of the docking region 11, but in other embodiments of the present disclosure, the load-bearing platform 111 can be provided on the rear side or both front and rear sides of the docking region 11.

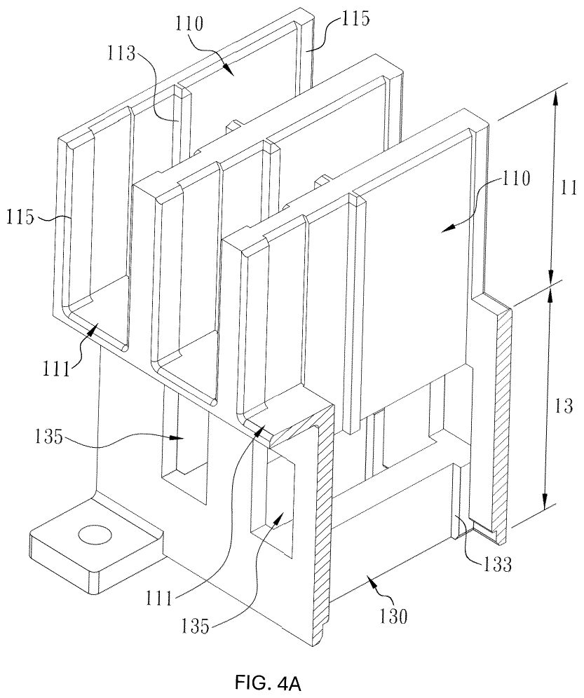

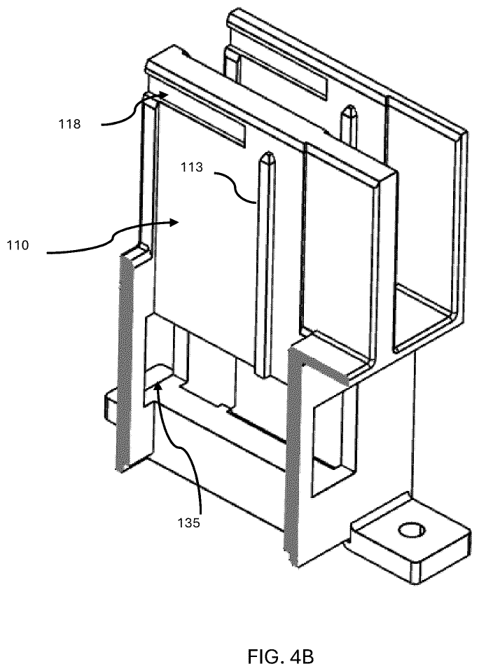

Continuing with the above, and referring to FIGS. 1 and 4A-4B, the docking region 11 comprises at least one first elongated protrusion 113 corresponding to an inner wall of the docking space 110. The first elongated protrusion 113 can be mated with the plug connector 3, so as to be embedded into or attached to the plug connector 3, thereby achieving the effect of guiding, positioning, fool-proofing or limiting. For example, the first elongated protrusion 113 may extend along the inner wall of the docking space 110 in the mating direction to guide the plug connector 3 in the mating direction. In that way, various plug connectors 3 can be engaged into a respective docking space 110 to allow for multiple plug connectors 3 to be reliably accommodated into the housing by docking region 11. In addition, the docking region 11 is further provided with a plurality of through openings 115. The through openings 115 extend along the longitudinal axis direction and are connected with the docking spaces 110. In some embodiments, the front and rear sides of the docking region 11 are each provided with a through opening 115. In this way, for the plug connector 3 with connection structures on both front and rear sides, it can still maintain its original transmission function after being inserted into the housing 1. For example, the front side of the plug connector 3 comprises a first connection end 33, and the first connection end 33 may be in the form of a slot for another connector to be plugged in. The rear side of the plug connector 3 comprises a second connection end 34, and the second connection end 34 can be connected to an electronic wire S. In an implementation, the front and rear sides of the plug connector 3 can exceed the housing 1 through the corresponding through openings 115. Alternatively, in other embodiments, the front side of the plug connector 3 does not exceed the housing 1, and another connector can extend into the housing 1 through the corresponding through opening 115, and be plugged into the first connection end 33 of the plug connector 3. Alternatively, in other embodiments, the rear side of the plug connector 3 does not exceed the housing 1, and the electronic wire S can extend into the housing 1 through the corresponding through opening 115 and be fixed to the second connection end 34 of the plug connector 3. For example, in other embodiments of the present disclosure, according to needs in fields, the docking region 11 can comprise a through opening 115 only on the front side or the rear side. Further, in some embodiments, the docking region 11 may include a latch opening 118 configured to receive a latching member of plug connector 3. For example, when the plug connector 3 is inserted into the housing into the mated position, the latch member of plug connector 3 may be received by the latch opening 118 to hold the plug connector 3 in a secure latched position.

In addition, referring to FIGS. 1, 4A-B and 5A-5B, the mating region 13 comprises a plurality of mating spaces 130, and the mating spaces 130 and the docking spaces 110 correspond to each other, and are connected with each other, so that when the socket connector 2 is assembled into the docking space 110, the plug terminal 33 of the plug connector 3 can be electrically connected to the receiving terminal 22 of the socket connector 2 through the docking spaces 110 and the mating spaces 130 in sequence. In addition, the mating region 13 comprises at least one second elongated protrusion 133 corresponding to an inner wall of the mating space 130. The second elongated protrusion 133 can be mated with the socket connector 2, so as to be embedded into or attached to the socket connector 2, thereby achieving the effect of guiding, positioning, fool-proofing and/or limiting. For example, the first elongated protrusion 113 may extend along the inner wall of the docking space 110 in the mating direction to guide the plug connector 3 in the mating direction. In that way, various socket connectors 2 can be engaged into a respective mating space 130 to allow for multiple socket connectors 2 to be reliably accommodated into the housing by mating region 13. As such, when a user plugs the plug connector 3 into the socket connector 2, through the design of the load-bearing platform 111, the following advantages can be achieved:

(1) when the plug connector 3 is pressed, the user can quickly know that the plug connector 3 and the socket connector 2 have been plugged in through the blocking feel of the load-bearing platform 111, which may help improve case of use.

(2) The load-bearing platform 111 may prevent the plug connector 3 from excessive downward displacement. For example, it may prevent excessive force from being distributed to mating portions of plug connector 3 and socket connector 2 and causing the plug connector 3 to excessively press the socket connector 2 and cause damage.

(3) The load-bearing platform 111 further has a guiding effect. The user may press the mating surface of the plug connector 3 against the load-bearing platform 111 and slide on the load-bearing platform 111 to smoothly move to a position corresponding to the mating space 130, so that it is plugged downward into the socket connector 2 into a mated position.

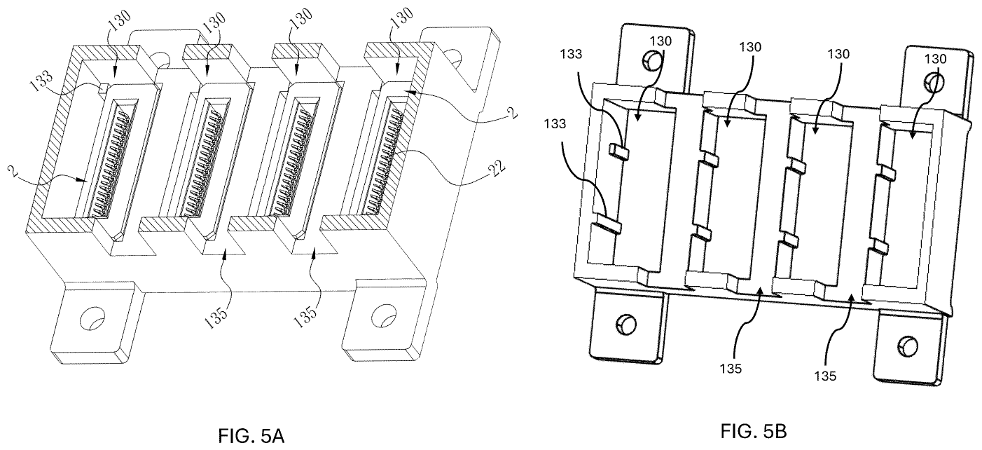

Also, referring to FIGS. 1, 4A-4B and 5A-5B, the mating region 13 may comprise at least one ventilation hole 135, and the ventilation hole 135 extends along the longitudinal axis direction and can run through opposite sides (i.e., the front side and the rear side) of the mating region 13. Also, the ventilation hole 135 may be located between two adjacent mating spaces 130. In some embodiments, the ventilation hole 135 is connected with an adjacent mating space 130, so that the heat generated during the operation of the socket connector 2 and the plug connector 3 can be quickly dissipated through the ventilation hole 135. For example, according to product requirements, the ventilation hole 135 can be connected to one of the mating spaces 130, or not connected with any mating space 130. The heat in the mating space 130 can still escape through the thin wall between the ventilation hole 135 and the mating space 130.

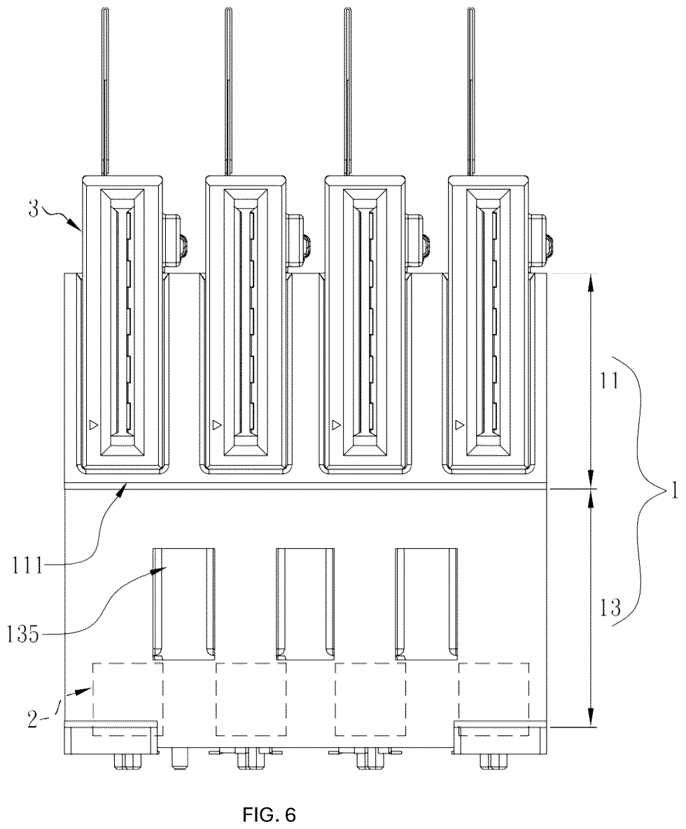

Furthermore, referring to FIGS. 1 and 4 to 6, in some embodiments, the height of the top surface of the socket connector 2 can be lower than the height of the top surface of the mating region 13, and even the height of the top surface of the socket connector 2 does not exceed the position of the bottom side of an adjacent ventilation hole 135, so that the following effects can be achieved:

(1) When the plugging position of the plug connector 3 is inaccurate, it can be blocked by the load-bearing platform 111 first and will not directly hit the socket connector 2, thereby reducing the probability of damage to the socket connector 2.

(2) Since the position of the socket connector 2 is low, the plugging positions of the socket connector 2 and the plug connector 3 will be deeper into the housing 1, ensuring the stability of plugging, and it is less likely to cause incorrect detachment due to external force (such as shaking, collision, etc.).

(3) When the ventilation hole 135 is connected with the mating space 130, the socket connector 2 at a lower position can reduce or avoid electromagnetic interference through the inner wall (i.e., a wall between two adjacent mating spaces 130) of the housing 1.

(4) If the socket connector 2 and the plug connector 3 are high-speed transmission connectors, their plugging positions are closer to the ventilation holes 135, so that the heat generated during operation is easier to dissipate through the ventilation holes 135, so as to achieve a better heat dissipation effect.

As discussed herein, the housing of the connectors described herein may be made of metal. For example, in some embodiments, the housing may be die-cast metal and formed by injecting metal into a mold under high pressure. In some embodiments, the die-case metal may include one or more of, aluminum, zinc, and/or magnesium alloys. Die-cast metal may provide greater strength and durability for high-stress applications. In some embodiments, the housing may be cut and formed from sheet metal. In some embodiments, the sheet metal may include one or more of steel, aluminum, and/or stainless steel. Forming the housing from sheet metal may provide lower costs for forming low-volume connectors in lower-stress applications.

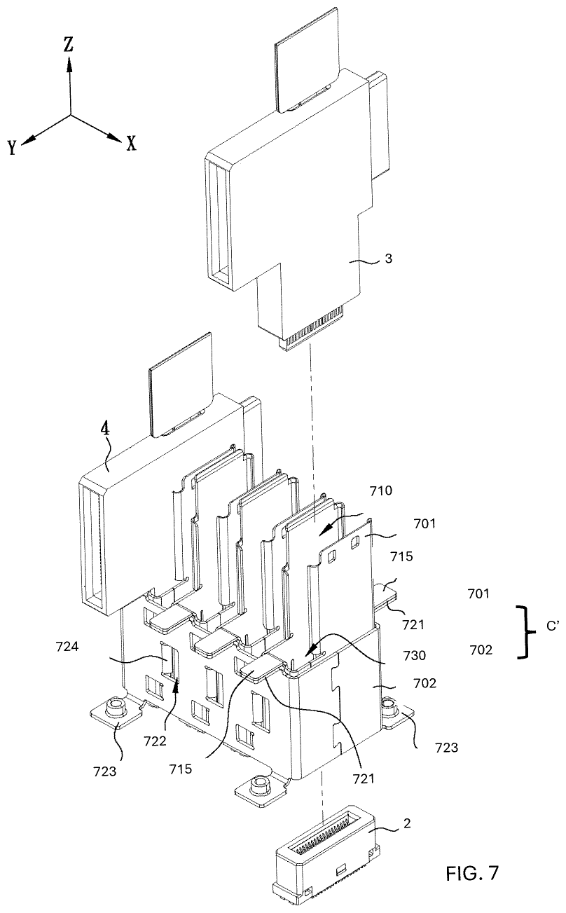

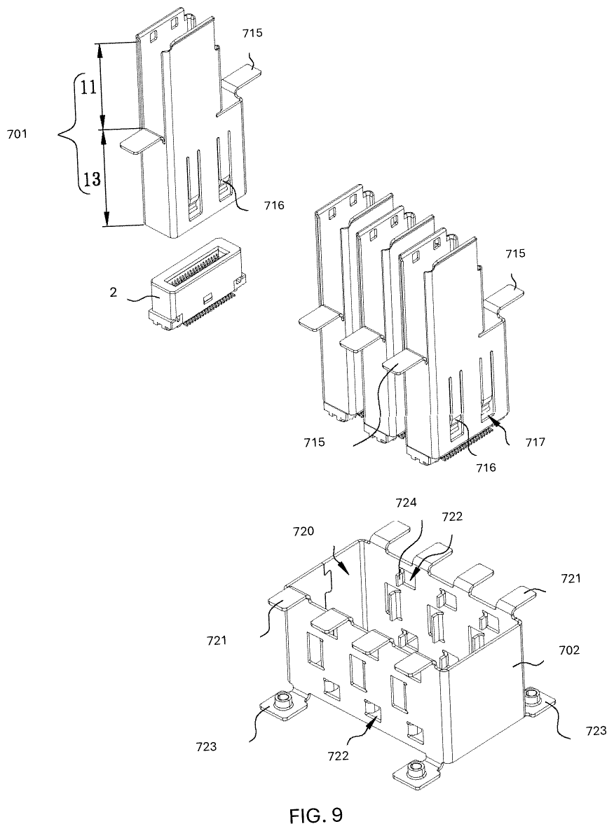

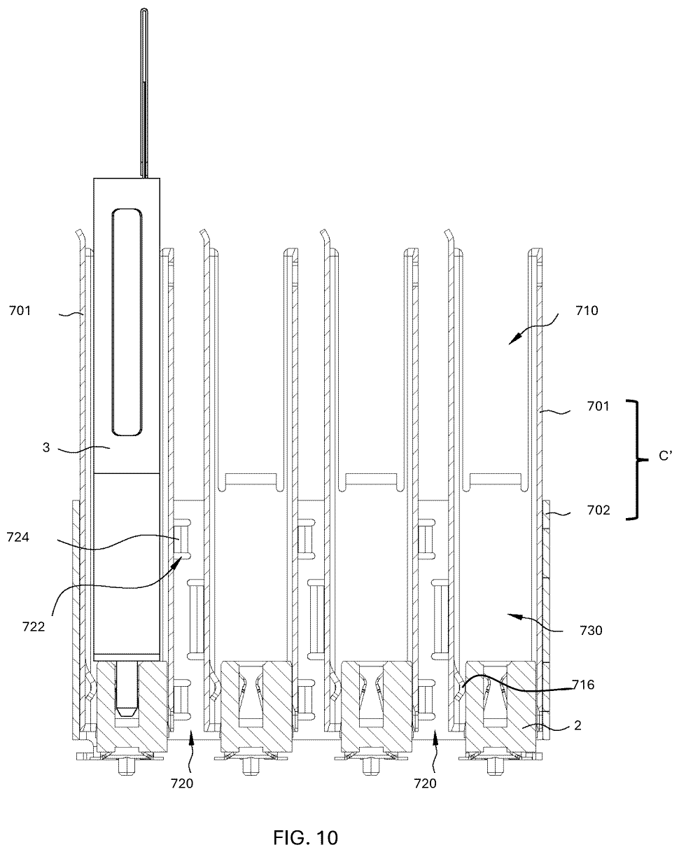

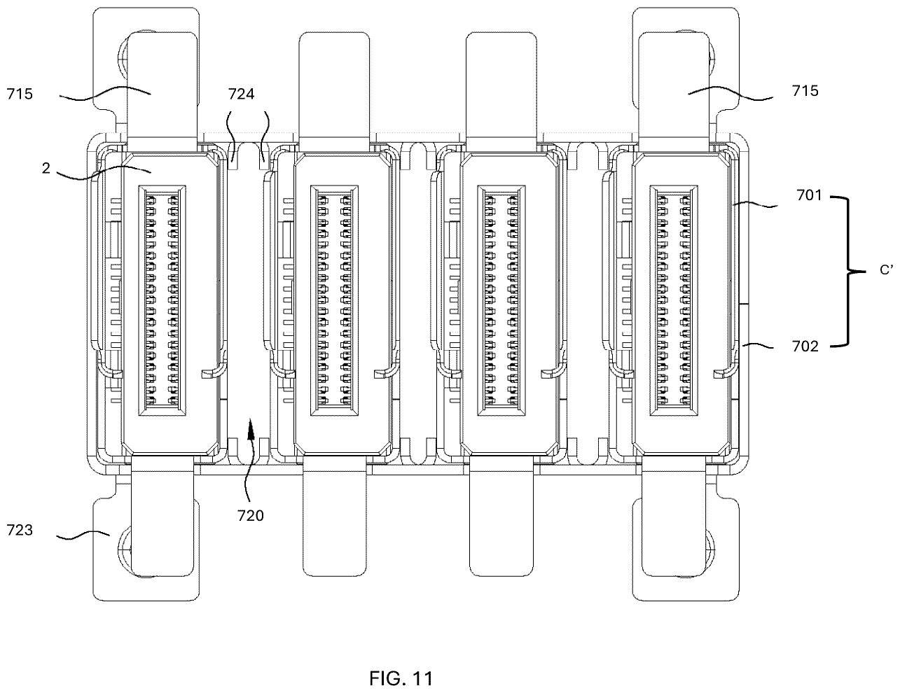

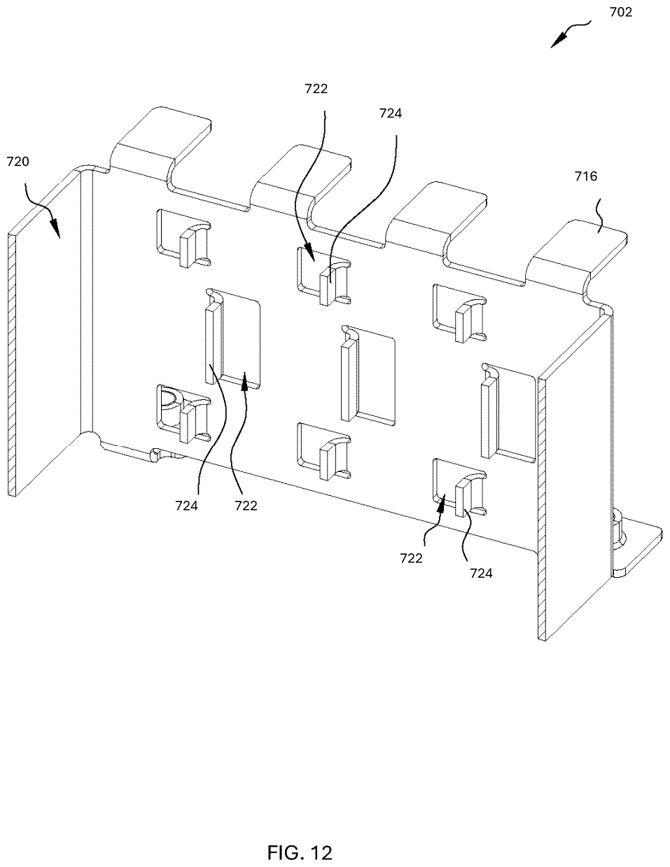

FIGS. 7 to 12 depict an alternative connector assembly having a housing for holding multiple connectors, according to some embodiments. In some embodiments, the housing may be configured to be modular to allow for increased design flexibility while maintaining load-bearing properties.

In some embodiments, as shown in FIG. 7 to FIG. 9, the connector housing C′ may comprise a plurality of inner shells 701 and an outer shell 702, wherein the inner shells 701 can be fixed to the outer shell 702. A plurality of socket connectors 2 can be assembled into the connector housing C′, and a plurality of plug connectors 3 can be plugged into the corresponding socket connectors 2 through the connector housing C′. Further, when the form of the socket connector 2 or the plug connector 3 has changed, the original outer shell 2 can be used by simply replacing the form of the inner shell 1, therefore the modular design of the connector housing C′ allows that the connector is durable and flexible, while allowing a reduction of production and maintenance costs.

Referring to FIG. 7 to FIG. 9, the inner shell 701 can be made of a metal material and can include a docking region 11 and a mating region 13 aligned in the mating direction. A length of the docking region 11 in the longitudinal axis direction is smaller than the length of the mating region 13 in the longitudinal axis direction, and at least one first platform 715 is provided on the top edge of the mating region 13 facing outward (along the longitudinal axis direction), but the present disclosure is not limited thereto. In other embodiments, the length of the docking region 11 in the longitudinal axis direction can be greater than the length of the mating region 13 in the longitudinal axis direction, and the first platform 715 may extend outward from the bottom edge of the docking region 11. In yet other embodiments, the length of the docking region 11 in the longitudinal axis direction is the same as the length of the mating region 13 in the longitudinal axis direction, and the first platform 715 extends outward from the junction of the docking region 11 and the mating region 13. In addition, besides the length of the inner shell 701 in the longitudinal axis direction being variable, the length of the docking region 11 in the vertical axis direction can also be the same as or different from the length of the mating region 13 in the vertical axis direction. Further, in some embodiment, a first platform 715 extends outward from the front and rear ends of the inner shell 701, respectively. In some embodiments, the inner shell 701 may comprise one first platform 715, wherein, for example, the inner shell 701 comprises a first platform 715 only at the front end or comprises a first platform 715 only at the rear end.

Referring to FIG. 7 to FIG. 9 again, the docking region 11 comprises a docking space 710, the docking space 710 being concave downward and extending at least from the top side of the inner shell 701. In some embodiments, the front and rear ends of the docking region 11 are provided with openings, which can respectively communicate with the docking space 710, but the present disclosure is not limited thereto. In some embodiments, neither the front end nor the rear end of the docking region 11 may comprise an opening, or only one end (the front or rear end) thereof may comprise an opening. Further, the docking space 710 is configured to accommodate the plug connector 3, and a part of the plug connector 3 may extend beyond the docking space 710 and press against the first platform 715 to improve the stability of the plug connector 3 in the inner shell 701 and prevent damage to plug connector 3 due to excessive force being used during mating.

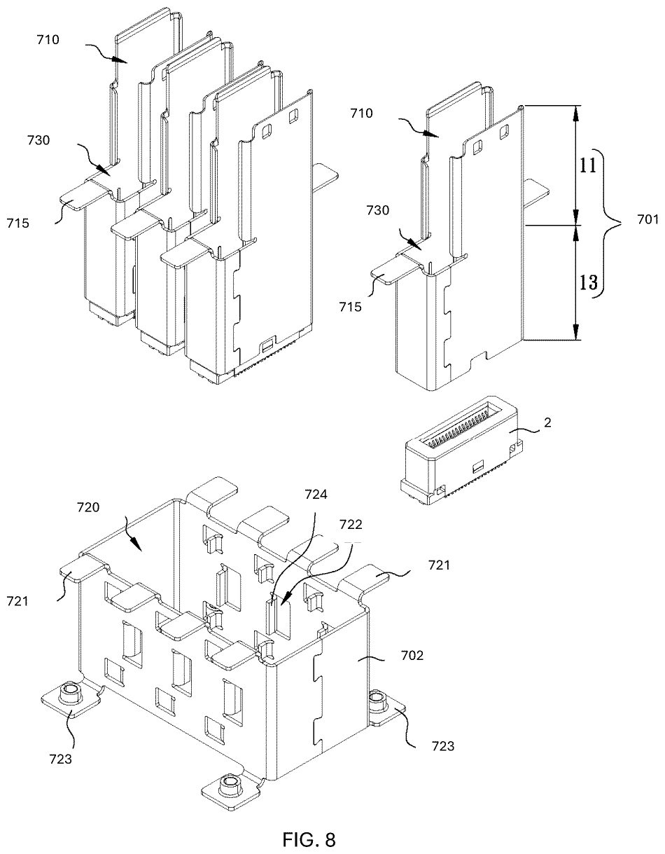

Further, in some embodiments, docking space 710 may include a wall having a latch hole to secure a plug connector 3 into docking space 710 when the plug connector 3 is in a mated position. For example, as depicted in FIG. 8, docking space 710 includes latch hole 712. Latch hole 712 may be configured to receive a latching member of the plug connector 3 when the plug connector 3 is inserted into docking space 710 and placed into a mated position. In some embodiments, latch hole 712 may be positioned on a side of docking region 11 opposite the mating region 13. In some embodiments, latch hole 712 may have a shape corresponding to a shape of the latching member of the plug connector 3. For example, the latching member may engage with latch hole 712 when plug connector 3 is in a mated position.

Referring to FIG. 7 to FIG. 10, the mating region 13 comprises a mating space 730, and the mating space 730 may be connected to the docking space 710, so the plug connector 3 can extend into the mating space 730 through the docking space 710. The mating space 730 may be further configured to accommodate a socket connector 2. In this embodiment, the position of a mating surface (for example, the top surface) of the socket connector 2 may be lower than the junction of the docking region 11 and the mating region 13, so the plug connector 3, after extending into the inner shell 701 in the mating direction, will pass through the docking space 710 and the mating space 730 (at least partially) in sequence and be plugged into the socket connector 2. For example, in other embodiments, when a mating surface of the socket connector 2 is substantially flush with the junction of the docking region 11 and the mating region 13 or higher than the junction of the docking region 11 and the mating region 13, the plug connector 3 may not extend into the mating space 730.

Further, in order to allow the socket connector 2 to be securely positioned in the inner shell 701, one side (for example, a left side) of the inner shell 701 can comprise at least one locking portion 716, and, in some embodiments, the locking portion 716 is stamped from a local area of the inner shell 701, which may be elastic and can press against the socket connector 2 located in the mating space 730, so when the socket connector 2 slightly varies in thickness due to a tolerance, the locking portion 716 can press against the socket connector 2 due to the elastic deformation, thereby keeping the socket connector 2 in a predetermined position. For example, in other embodiments, the inner shell 701 can also adopt another structure or method to fix the socket connector 2.

Referring to FIG. 7 to FIG. 9 again, the outer shell 2 can be made of a metal material and internally provided with an accommodating space 720, wherein the accommodating space 720 will penetrate the outer shell 702 in the mating direction and allows the inner shell 701 to be assembled therein. Further, the top of the outer shell 702 comprises a plurality of second platforms 721 extending outward in the longitudinal axis direction. The bottom of the outer shell 702 may comprise at least one positioning portion 723. The second platforms 721 correspond to the first platforms 715 respectively, so when the inner shell 701 is assembled in the mating direction into the outer shell 702, the mating region 13 of the inner shell 701 will extend into the accommodating space 720 until the first platform 715 presses against and is fixed to the second platform 721, so that the outer shell 702 and the inner shells 701 jointly form the connector housing C′. In some embodiments, the first platform 715 and the second platform 721 are fixed to each other by welding, so that the first platform 715 and the second platform 721 are unlikely to be separated by an external force, and the superimposed first platform 715 and second platform 721 can also provide strong load-bearing support to the plug connector 3. Further, the positioning portion 723 can extend outward along the longitudinal axis direction to be flush with and be fixed to a circuit board, and improve the stability of the outer shell 702 on the circuit board. Thus, by means of the modular design of the present disclosure, manufacturers can replace inner shells 701 of different types and appearances according product features, and fix each inner shell 701 to the outer shell 702. The forms of individual inner shells 701 in the connector housing C′ can be the same or different from each other, which greatly improves the flexibility in production and convenience of customization. Further, since adjacent socket connectors 2 or adjacent plug connectors 3 are separated by an inner shell 701, electromagnetic interference can be effectively reduced to maintain good transmission efficiency.

Further, if the socket connector 2 and the plug connector 3 are high-speed transmission connectors, large amounts of heat are likely generated when they operate. Referring to FIG. 7 to FIG. 11, in order to improve heat dissipation efficiency, the inner shells 701 can be arranged in the outer shell 702 along the horizontal axis direction, and two adjacent inner shells 701 are separated from each other by a distance, and, further, two opposite sides (such as the front and/or rear sides) of the outer shell 702 can comprise a plurality of ventilation holes 722 respectively, the ventilation holes 722 being capable of communicating with the accommodating space 720, wherein the ventilation holes 722 can correspond to the area between two adjacent inner shells 701. The inner shell 701 may also comprise an opening 717, the opening 717 allowing the mating space 730 and the accommodating space 720 to communicate with each other, so the heat generated during the operation of the socket connector 2 and the plug connector 3 can be dissipated to the area between two adjacent inner shells 701 through the opening 717 and the heat dissipation ability of the metal of the inner shell 701, and then be quickly dissipated to the outside through the ventilation holes 722 to avoid the accumulation of heat in the inner shells 701. For example, in some embodiments, the inner shell 701 may not comprise the opening 717. In some embodiments, the outer shell 702 can comprise a ventilation hole 722 on one side (for example, the front or rear side) thereof. In some embodiments, the inner shells 701 are substantially pressed against each other. In some embodiments, the outer shell 702 may not comprise ventilation hole 722.

Referring to FIG. 7 to FIG. 11, when two adjacent inner shells 701 are separated from each other, to maintain the distance between them and reduce the possibility of the shells warping or pressing against each other due to an external force during use, in some embodiments, at least one inner side (for example, the front and/or rear side) of the outer shell 702 is further provided with a plurality of limit portions 724, and, referring to FIG. 12, the limit portions 724 on the same side can be arranged in the horizontal axis direction. Two adjacent limit portions 724 may be located between two adjacent inner shells 701 and respectively press against different inner shells 701, so that two adjacent inner shells 701 are blocked by the limit portions 724, unlikely to press against each other due to an external force. Further, a plurality of limit portions 724 can also be arranged along the vertical axis direction to be able to press against different areas of the same inner shell 701, so when the inner shell 701 has a great length, the pressing effect produced by the limit portions 724 can keep the inner shell 701 straight and unlikely to warp.

Referring to FIG. 7 to FIG. 12 again, in order to improve the convenience of production operations, in some embodiments, the outer shell 702 can be stamped into a ventilation hole 722 and a limit portion 724 by one stamping, and, as shown in FIG. 12, a local area of the outer shell 702 may be bent inward by stamping, in which case the bent part can form a limit portion 724, while the original position will split to form a ventilation hole 722, but the present disclosure is not limited thereto. In some embodiments, ventilation hole 722 and a limit portion 724 may be formed in the outer shell 2 by different processes, and a ventilation hole 722 and a limit portion 724 may be located in different positions, without being adjacent to each other.

Some embodiments relate to a housing configured for holding multiple connectors. The housing may include a docking region. The docking region may comprise a plurality of docking spaces to accommodate a plurality of plug connectors. A length of the docking region in a longitudinal axis direction may be greater than that of a mating region to form a load-bearing platform. The load-bearing platform can be configured to abut against the plug connectors. The housing may additionally or alternatively include a mating region. The mating region may comprise a plurality of mating spaces to accommodate a plurality of socket connectors. The mating spaces may be connected with the docking spaces, respectively. The docking region and the mating region may be aligned in a mating direction.

Optionally, the housing is made of metal.

Optionally, the docking region comprises at least one first elongated protrusion corresponding to an inner wall of the docking space.

Optionally, the mating region comprises at least one second elongated protrusion corresponding to an inner wall of the mating space.

Optionally, the docking region comprises a plurality of through openings, wherein the through openings extend along the longitudinal axis direction and are connected with the docking spaces.

Optionally, the mating region comprises at least one ventilation hole, wherein the ventilation hole extends along the longitudinal axis direction, runs through opposite sides of the mating region, and is located between two adjacent mating spaces.

Optionally, the ventilation hole is connected with at least one of the mating spaces.

Some embodiments described herein relate to a connector assembly with multiple connectors, comprising: the housing according to any of the embodiments described herein; and a plurality of socket connectors, which are assembled into the docking spaces of the housing, respectively.

Optionally, a height of a top surface of the socket connector is lower than a height of a top surface of the mating region.

Optionally, the height of the top surface of the socket connector does not exceed a position of a bottom side of an adjacent ventilation hole.

Some embodiments described herein relate to a housing configured for holding multiple connectors. The housing may comprise a plurality of inner shells and an outer shell. The inner shells may include a docking region and a mating region aligned in a mating direction. The outer side of each inner shell may include at least one first platform. The first platforms of the same inner shell may be located at or near the junction of the docking region and the mating region. The docking region may comprise a docking space configured to accommodate a male connector. The mating region may comprise a mating space configured to accommodate a female connector. The mating space and the docking space may be connected with each other. The top of the outer shell may comprise a plurality of second platforms facing outward. An accommodating space may be provided inside the outer shell. When each inner shell is assembled into the accommodating space, the second platforms may press against and are fixed to the corresponding first platforms.

Optionally, the inner shells are separated from each other by a distance.

Optionally, at least one side of the outer shell comprises a plurality of limit portions.

Optionally, two adjacent limit portions, respectively, press against different inner shells.

Optionally, at least one side of the outer shell comprises a plurality of through holes, each of which is connected with the accommodating space.

Optionally, a local area of the outer shell will be bent inward by stamping to form the limit portion, and the through hole will be formed in its original position.

Optionally, the first platform and the second platform are fixed to each other by welding.

Optionally, one side of the inner shell comprises at least one locking portion that can press inward against the female connector of the mating space.

Optionally, the inner shell comprises an opening that allows the mating space and the accommodating space to communicate with each other.

Optionally, the length of the docking region is different from that of the mating region in the longitudinal axis direction and/or vertical axis direction.

Optionally, the bottom end of the outer shell comprises at least one positioning portion for fixation to a circuit board.

Although the preferred embodiments of the present disclosure are described above, the scope as claimed by the present disclosure is not limited thereto. According to the technical content disclosed by the present disclosure, a person of ordinary skill in the art can easily conceive of equivalent changes without departing from the scope of protection of the present disclosure.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A housing for holding a plurality of connectors, the housing comprising:
a first portion comprising a plurality of first spaces configured to receive a plurality of first connectors; and
a second portion comprising a plurality of second spaces connected to respective first spaces of the plurality of first spaces and configured to receive a plurality of second connectors, the plurality of second connectors configured to mate with the plurality of first connectors in a mating direction, wherein:
the first portion comprises a platform comprising a surface in a plane perpendicular to the mating direction at an interface of the first portion and the second portion.

2. The housing of claim 1, wherein an inner wall of the first portion comprises at least one first elongated protrusion, the at least one first elongated protrusion extending along the inner wall of the first portion in the mating direction.

3. The housing of claim 1, wherein an inner wall of the second portion comprises at least one second elongated protrusion, the at least one second elongated protrusion extending along the inner wall of the second portion in the mating direction.

4. The housing of claim 3, wherein the housing comprises die-cast metal.

5. The housing of claim 1, wherein the first portion comprises a plurality of openings extending into the plurality of first spaces along a first direction perpendicular to the mating direction.

6. The housing of claim 5, wherein the second portion comprises at least one ventilation hole extending along the first direction from a first side of the second portion to a second side of the second portion, opposite the first side.

7. The housing of claim 6, wherein the at least one ventilation hole is positioned between two adjacent second spaces of the plurality of second spaces.

8. The housing of claim 1, wherein the first spaces are each configured to receive a respective plug connector and the second spaces are each configured to receive a respective socket connector.

9. The housing of claim 1, wherein:
the platform is a first platform extending from a first side of the first portion; and
the housing further comprises a second platform extending from a second side of the first portion opposite the first side.

10. The housing of claim 1, wherein the first portion and the second portion are separably coupled.

11. The housing of claim 1, wherein each second space of the plurality of second spaces comprises a limit portion extending from an inner wall of the second portion and configured to position adjacent second connectors apart from each other.

12. A connector assembly comprising:
a housing comprising:
a first portion comprising a plurality of first spaces and a second portion comprising a plurality of second spaces, wherein:
the first portion comprises a platform adjacent to the second portion having a surface in a plane perpendicular to a mating direction, and
each first space of the plurality of first spaces is connected with a respective second space of the plurality of second spaces; and
a plurality of first connectors disposed in the plurality of first spaces; and
a plurality of second connectors disposed in the plurality of second spaces and connected with respective ones of the plurality of first connectors.

13. The connector assembly of claim 12, wherein the plurality of first connectors extend from the plurality of first spaces into the plurality of second spaces to mate with the plurality of first connectors.

14. The connector assembly of claim 13, wherein the platform is positioned to block movement of the plurality of first connectors toward the plurality of second connectors when the first connectors are in a mated position.

15. The connector assembly of claim 14, wherein the platform is positioned to abut a first end of each first connector when each first connector of the plurality of first connectors is mated with a respective second connector of the plurality of second connectors.

16. The connector assembly of claim 15, wherein the respective first end of each first connector comprises a slot configured to receive a third connector.

17. The connector assembly of claim 12, wherein a height of a top surface of each second connector is lower than a height of a top surface of the second portion.

18. The connector assembly of claim 12, wherein the first spaces of the plurality each comprise an opening extending into the first spaces along the first direction and the first connectors of the plurality each comprise a connection end configured to extend through a respective opening in the first direction.

19. The connector assembly of claim 12, wherein at least one first space of the plurality of first spaces comprises a wall having a latch hole configured to receive a latching member of one first connector of the plurality of first connector.

20. A housing for holding a plurality of connectors, the housing comprising:
a plurality of shells extending along a mating direction each configured to hold a first connector and a second connector, each of the plurality of shells comprising a first end for holding the first connector and a second end opposite the first end for holding the second connector; and
a platform extending from each of the plurality of shells between the first end and the second end, the platform having a surface perpendicular to the mating direction and configured to abut the plurality of first connectors.

21. The housing of claim 20, wherein:
the plurality of shells are a plurality of inner shells; and
the housing comprises an outer shell, wherein each inner shell is separably coupled to the outer shell.

22. The housing of claim 21, wherein:
the platforms of each inner shell are first platforms; and
the outer shell comprises a second platform having a surface perpendicular to the mating direction and configured to abut the first platform of one or more inner shells when coupled to the inner shell.

23. The housing of claim 22, wherein:
the second platform is welded to the first platform of a respective inner shell when the respective inner shell and outer shell are coupled.
